(19) United States
(12) Patent Application Publication
(10) Pub. No.: US 2007/0076160 A1
(43) Pub. Date: Apr. 5, 2007

(54) Liquid crystal display device

(75) Inventors: Ken Shiiba, Ishikawa-ken (JP); Hiroshi Azuma, Ishikawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Minato-ku (JP)

(21) Appl. No.: 11/513,301

(22) Filed: Aug. 31, 2006

(30) Foreign Application Priority Data
Sep. 30, 2005 (JP) 2005-288780

(51) Int. Cl. G02F 1/1339

(52) U.S. Cl. 349/153

(57) ABSTRACT

An LCD device includes pixel array substrate 12, counter substrate 14, transfer members 22 to supply a power source voltage between pixel array and counter substrates 12 and 14 and sealing member 16 to assemble pixel array substrate 12 with counter substrate 14. A gap defined between pixel array substrate 12 and counter substrate 14 with sealing member 16 is set to be bigger than that defined at a display region of the LCD device. Sealing member 16 is provided detouring around transfer members 22 toward the display region. A step is defined between the height of pixel array substrate 12 at the portions detouring around transfer members 22 and that of pixel array substrate 12 at other portions than the portions detouring around transfer members 22 so that the former is lower than the latter.

### CROSS-REFERENCE OF RELATED APPLICATIONS

This application is based upon and claims the benefit of priority from the prior Japanese Patent Application No. 2005-288780, filed on Sep. 30, 2005, the entire contents of which are incorporated herein by reference.

### FIELD OF THE INVENTION

This invention generally relates to a liquid crystal display device.

### BACKGROUND OF THE INVENTION

A liquid crystal display (LCD) device includes a pixel array substrate and a counter substrate. The pixel array substrate is assembled with the counter substrate by a sealing member provided at circumferences around the outside of a display region on the LCD device. A liquid crystal layer is formed at spaces defined between such assembled pixel array and counter substrates.

Further, electrically conductive transfer members are provided at the outside of the display region to supply electric power from the pixel array substrate to a common electrode of the counter substrate.

Conventional structure of the sealing member and the transfer members will be described below with reference to FIGS. 5-7.

Since LCD device 110 has recently required a narrow frame to use display region 111 as efficiently as possible, sealing member 100 is coated to detour around but to extend adjacently to display region 111 of pixel array substrate 112 in order for sealing member 100 to avoid or not to overlap transfer member 102 as shown in FIG. 7.

As shown in FIGS. 5 and 6, filler 104 made of glass fibers or a suitable substitute is added to sealing member 100 to maintain a predetermined gap size.

Gap “A” of sealing member 100 is taller than that of gap “B” of display region 111 to define a stably configured gap around the circumferences between pixel array substrate 112 and counter substrate 114 as shown in FIGS. 5 and 6.

As shown in FIG. 7, since a part of sealing member 100 crosses leading lines 106, pixel array pattern 108 that is the same in height as leading lines 106 is formed on pixel array substrate 112 to make pixel array and non-leading-line potions uniform in height.

In such conventional structure as set forth above, portions of big differences in height exist between gaps “A” and “B” defined by sealing member 100 detouring around transfer member 102 in the vicinity of display region 111 as shown in FIG. 6. Such differences affect optical characteristics of display region 111 and cause uneven display of the image being displayed. In other words, changes in optical characteristics due to height differences are so remarkable in the vicinity of gap “C” shown in FIG. 6 to cause uneven display of the image being displayed.

In order to improve position accuracy of sealing members, a technique to form a convex step on a pixel array substrate has been proposed (in Japanese Patent Publication Hei 7-209675, for instance).

In this technique, a rectangular frame-like convex step is formed on portions of the pixel array substrate. A sealing material is then coated on the portions where capillary-tube-like gaps are defined between the pixel array and counter substrates by the sealing material to relatively reduce sizes of the gaps.

Even with such structure that the convex step is formed on the pixel array substrate and the sealing material is coated on the convex step, the portions around the transfer member are subjected to big gap changes that cause the same to have uneven display of the image being displayed as the conventional LCD device set forth above with reference to FIGS. 5-7.

As described above, the gaps defined between the pixel array and counter substrates significantly change in height in the detouring portions around the transfer members in the prior art devices so that such changes cause uneven display of the image being displayed.

### SUMMARY OF THE INVENTION

Accordingly, it is an object of the present invention to provide an LCD device that can solve such a technical problem and in which gaps defined between pixel array and counter substrates do not significantly change in height in detouring portions around transfer members so that uniform display can be performed.

An aspect of the present invention is directed to a liquid crystal display device including a first substrate having a display region, a second substrate provided opposite to the first substrate, an electrically conductive transfer member to supply a voltage between the first and second substrate, a sealing member provided at circumferences of the display region and at portions detouring around the transfer member toward the display region to assemble the first substrate with the second substrate, and a liquid crystal layer provided between the first and second substrate. In the liquid crystal display device, a first gap defined at the circumferences of the display region between the first and second substrates is bigger than a second gap defined at the display region between the first and second substrates, and the sealing member provided at the portions detouring around the transfer member is lowered in height toward the display region in order for the second gap to be substantially uniform.

According to the present invention, since the height of the sealing member at the portions detouring around the transfer member is lower than that of the sealing member at other portions than those detouring around the transfer member, gap changes are insignificant so that uneven display of the image being displayed can be avoided.

### BRIEF DESCRIPTION OF THE DRAWINGS

A more complete appreciation of the present invention and many of its attendant advantages will be readily obtained as the same becomes better understood by reference to the following detailed descriptions when considered in connection with the accompanying drawings, wherein:

FIG. 1 is a schematic plan view of a pixel array substrate of an LCD device in accordance with an embodiment of the present invention;

FIG. 2 is a longitudinally sectional view of portions adjacent to a sealing member of the LCD device;

FIG. 3 is a longitudinally sectional view of portions adjacent to a transfer member of the LCD device;

FIG. 4 is a plan view of portions adjacent to the sealing member and the transfer member of the pixel array substrate;

FIG. 5 is a longitudinally sectional view of portions adjacent to a sealing member of a conventional LCD device;

FIG. 6 is a longitudinally sectional view of portions adjacent to a transfer member of the conventional LCD device; and

FIG. 7 is a plan view of portions adjacent to the sealing member and the transfer member of a conventional pixel array substrate.

### DETAILED DESCRIPTION OF THE INVENTION

Embodiments of the present invention will be explained below with reference to the attached drawings. It should be noted that the present invention is not limited to the embodiments but covers their equivalents. Throughout the attached drawings, similar or same reference numerals show similar, equivalent or same components. The drawings, however, are shown schematically for the purpose of explanation so that their components are not necessarily the same in shape or dimension as actual ones. In other words, concrete shapes or dimensions of the components should be considered as described in these specifications, not in view of the ones shown in the drawings. Further, some components shown in the drawings may be different in dimension or ratio from each other.

### Embodiment

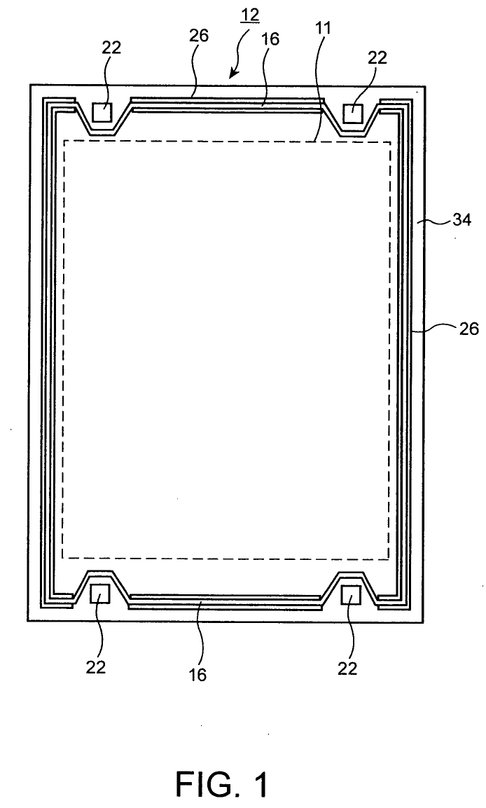

LCD device 10 in accordance with an embodiment of the present invention will be described below with reference to FIGS. 1-4.

(1) Overall Structure of LCD Device 10

LCD device 10 includes pixel array substrate 12, counter substrate 14 provided opposite to pixel array substrate 12, sealing member 16 to assemble pixel array substrate 12 with counter substrate 14 and liquid crystal layer 18 between pixel array substrate 12 and counter substrate 14.

Pixel array substrate 12 is provided with scanning and signal lines intersecting with each other at right angles and thin-film transistor (TFT) devices in the vicinities of intersecting points of the scanning and signal lines. Gate and source electrodes of the TFT devices are connected to the scanning and signal lines, respectively, while drain electrodes of the TFT devices are connected to pixel electrodes.

The scanning and signal lines are taken out from pixel array substrate 12 and are connected to scanning and signal line driver circuits. The scanning and signal lines taken out from pixel array substrate 12 are hereinafter collectively referred as the “leading lines 20”.

As shown in FIG. 1, four transfer members 22, i.e., electrically conductive pillar members, are provided at predetermined distances in frame portions of pixel array substrate 12, i.e., circumferences of display region 11 (indicated by dotted lines in FIG. 1). Transfer members 22 are pillar-like connecting members to supply a counter electrode of counter substrate 14 with a counter voltage applied to power supply line 24 disposed on pixel array substrate 12. The structure of transfer members 22 will be set forth in detail later on.

The circumferences of pixel array substrate 12 out of display region 11 are provided with frame-like sealing member 16 made from hardening resins such as thermosetting resin adhesives or any suitable substitute. Sealing member 16 is disposed toward the inner side of pixel array substrate 12 to detour around transfer members 22 as shown in FIG. 1. Sealing member 16 will be also explained in more detail later on.

Counter substrate 14 includes color filter layers formed on an insulation plate such as a glass plate, black matrix layers and the counter electrode.

(2) Structure of Sealing Member 16 and Transfer Members 22

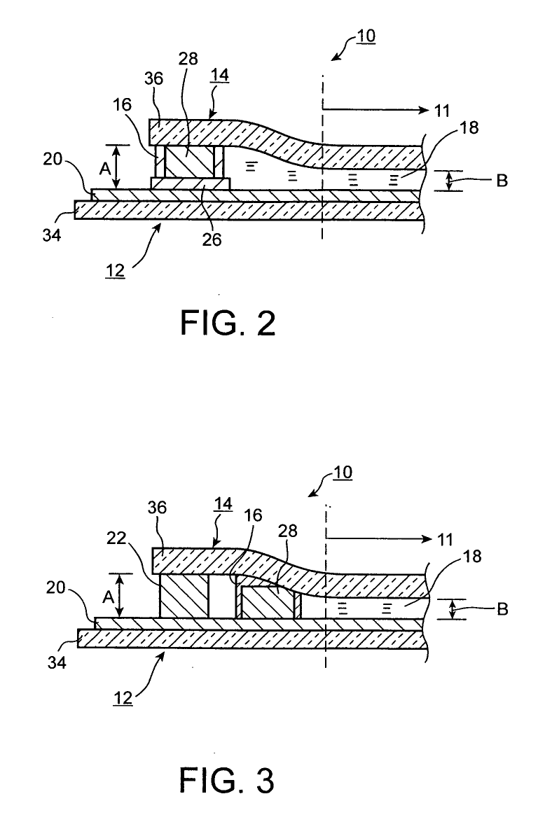

Next, structure of sealing member 16 and transfer members 22 will be explained below with reference to FIGS. 2-4.

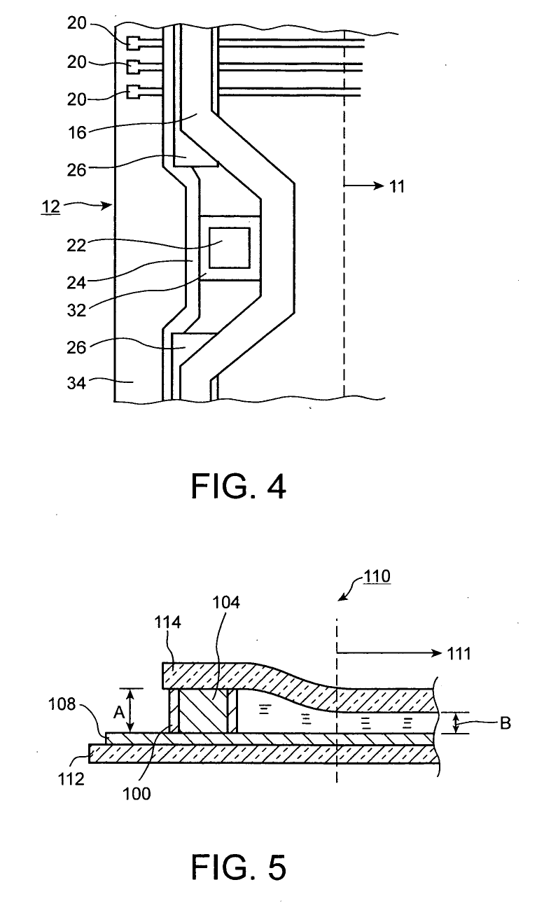

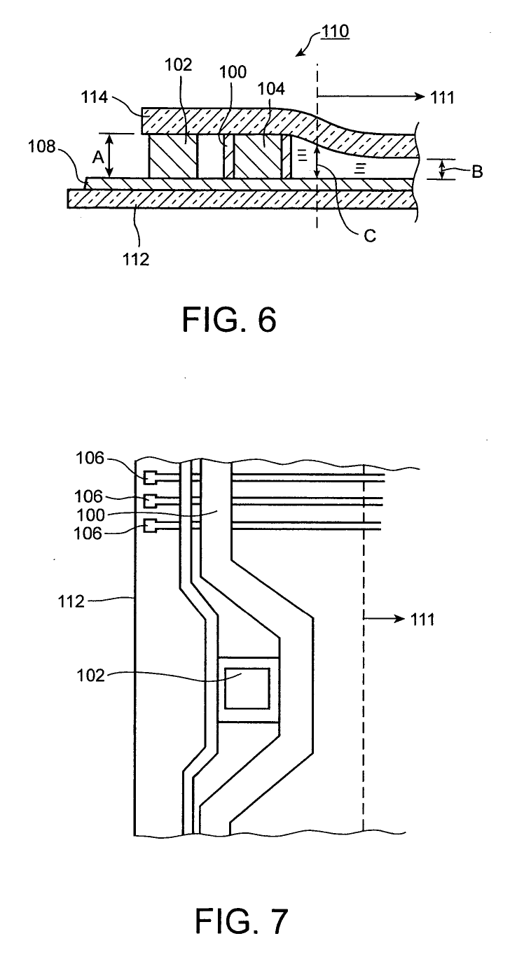

FIG. 2 shows a longitudinally sectional view of other portions in the vicinity of sealing member 16 than those detouring around transfer members 22 (called hereinafter the “straight line portions”). FIG. 3 is a longitudinally sectional view of portions adjacent to sealing member 16 detouring around transfer member 22. FIG. 4 is a plan view of a part of pixel array substrate 12 to show sealing member 16 in relation to its adjacent transfer member 22.

Pixel array patterns such as leading lines 20 are formed on isolation plate 34, such as a glass plate or a suitable substitute, of pixel array substrate 12. Further, additional patterns are formed for sealing member 16 to adjust its height at portions where sealing member 16 is disposed but no leading lines 20 are provided. Leading lines and additional patterns are collectively indicated by reference numeral 20 in FIGS. 2-4. Frame-like auxiliary patterns 26 are provided along portions on which sealing member 16 is coated. Frame-like auxiliary patterns 26 are provided around circumferences of isolation plate 36 except at portions where transfer members 22 are provided as shown in FIG. 1. After an isolation film is patterned on leading lines 20 and the additional patterns to maintain their electrical isolation, an electrically conductive film is formed on the isolation film in convex shapes. Frame-like auxiliary patterns 26 formed on pixel array substrate 12 are about 0.5 μm in height. No such frame-like auxiliary patterns 26 are formed at portions detouring around transfer members 22.

After frame-like auxiliary patterns 26 are formed as described above, sealing member 16 made from a hardening resin such as a thermo-setting resin or a suitable substitute is coated on portions of counter substrate 14 which correspond to frame-like auxiliary patterns 26 and the portions detouring around transfer members 22. In this case, sealing member 16 is coated in a character “C” shape from a plan view at the portions detouring around transfer members 22 (see FIG. 4). In order for sealing member 16 to maintain a predetermined height, filler 28 such as glass fibers or a suitable substitute is filled in a space defined in sealing member 16. Sealing member 16 is coated on the straight line portions as well as the detouring portions in the same manner as set forth above so that its height can be 5.0 μm, for instance.

Transfer members 22 are made of electrically conductive pastes such as pillar-like silver pastes, carbon pastes (including silver coated particles) or any suitable substitute and are formed on pixel array substrate 12. When pixel array substrate 12 is assembled with counter substrate 14, transfer members 22 are set on the detouring portions of sealing member 16.

Further, pad 32 connected to power supply line 24 is provided around transfer member 22. Thus, when pixel array substrate 12 is assembled with counter substrate 14, a voltage is supplied to the counter electrode of counter substrate 14 from pad 32 and transfer member 22.

When pixel array substrate 12 is assembled with counter substrate 14, sectional view structures of sealing member 16 and transfer member 22 are shown in FIGS. 2 and 3. Gap “A” defined by sealing member 16 and frame-like auxiliary pattern 26 around the circumferences is set to be bigger than gap “B” defined in display region 11. Since portions from gap “A” to gap “B” are out of display region 11, they do not affect optical characteristics of the LCD device or cause its uneven display of the image being displayed.

Since transfer members 22 are made from silver or carbon pastes but do not contain fillers for gaps, transfer members 22 do not substantially contribute to define gaps “A” at transfer members 22 (corresponding to gaps “A” defined by sealing member 16 and frame-like auxiliary patterns 26) or gaps “B” in display region 11 with respect to the detouring portions around transfer members 22 and gap “A” is set up by sealing member 16, the gap structures are the same as described above. In addition, sealing member 16 only exists in the detouring portions changing from gap “A” to gap B”. Since frame-like auxiliary patterns 26 is disposed in the straight line portions while no frame-like auxiliary patterns 26, however, exist in the detouring portions around transfer members 22, sealing member 16 with frame-like auxiliary patterns 26 in the straight line portions is higher by the heights of frame-like auxiliary patterns 26 than sealing member 16 without frame-like auxiliary patterns 26 in the detouring portions to form steps. In short, sealing member 16 in the detouring portions is relatively lower by the heights of frame-like auxiliary patterns 26 than sealing member 16 in the straight line portions. Further, since the thickness of sealing member 16 is the same as in other portions, the height of sealing member 16 at the detouring portions corresponds to that of the middle point between gaps “A” and “B”. In other words, since sealing member 16 without frame-like auxiliary patterns 26 which is lower in height by the thickness of frame-like auxiliary patterns 26 than sealing member 16 with frame-like auxiliary patterns 26 is disposed at such a preferable place of a gap reducing from gap “A” to gap “B” that its height is lower by the thickness of frame-like auxiliary patterns 26 than that of gap “A”, sealing member 16 without frame-like auxiliary patterns 26 does not substantially have an affect to define gap “B” but contributes to seal the LCD device. Accordingly, this structure does not cause any significant gap changes in display region 11. It does not result in substantial changes in optical characteristics or uneven display of the image being displayed.

(3) Effect of the Embodiment

As described above, a step is defined between sealing member 16 at the detouring portions around transfer members 22 and sealing member 16 at the straight line portions and the height of the former is lower than that of the latter. As shown in FIG. 3, since sealing member 16 is approximately set at a middle point of portions changing from gap “A” to gap “B” or, preferably, at such a point that counter substrate 14 is displaced by the height of sealing member 16, such a structure does not substantially influence gaps of display region 11 at the detouring portions around transfer members 22 or optical characteristics of display region 11, so that the structure does not cause uneven display of the image being displayed.

(Modification)

In the embodiment described above, frame-like auxiliary patterns 26 are provided at other places than transfer member 22 to add their height to sealing member 16. The present invention is not limited to such arrangements. Patterns of leading lines 22 or a suitable substitute at transfer members 22, for example, may be removed to intentionally lower the height at the detouring portions around transfer members 22. As a result, steps there are provided in relation to the straight portions to prevent gaps of display region 11 from changing.

Further, although frame-like auxiliary patterns 26 are formed on pixel array substrate 12 while sealing member 16 is formed on counter substrate 14 in the embodiment, frame-like auxiliary patterns 26 may be formed on counter substrate 14 while sealing member 16 is coated on pixel array substrate 12, or frame-like auxiliary patterns 26 and sealing member 16 may be provided on either pixel array substrate 12 or counter substrate 14 to achieve the same effect as in the embodiment.

In the foregoing description, certain terms have been used for brevity, clearness and understanding, but no unnecessary limitations are to be implied therefrom beyond the requirements of the prior art, because such words are used for descriptive purposes herein and are intended to be broadly construed. Moreover, the embodiments of the improved construction illustrated and described herein are by way of example, and the scope of the invention is not limited to the exact details of construction. Having now described the invention, the construction, the operation and use of embodiments thereof, and the advantageous new and useful results obtained thereby, the new and useful construction, and reasonable equivalents thereof obvious to those skilled in the art, are set forth in the appended claims.

What is claimed is:

1. A liquid crystal display device comprising:
a first substrate having a display region;
a second substrate provided opposite to the first substrate;
an electrically conductive transfer member to supply a voltage between the first and second substrate;
a sealing member provided at circumferences of the display region and at portions detouring around the transfer member toward the display region to assemble the first substrate with the second substrate; and
a liquid crystal layer provided between the first and second substrate, wherein a first gap defined at the circumferences of the display region between the first and second substrates is bigger than a second gap defined at the display region between the first and second substrates, and the sealing member provided at the portions detouring around the transfer member is lowered in height toward the display region in order for the second gap to be substantially uniform.

2. A liquid crystal display device according to claim 1, further comprising a film to form a step on the sealing member at the circumferences of the display region.

3. A liquid crystal display device according to claim 2, wherein the seal member provided at circumferences of the display region is substantially equal in height to that at portions detouring around the transfer member.

4. A liquid crystal display device according to claim 2, wherein the film includes a pattern for a pixel array circuit provided in the display region.

5. A liquid crystal display device according to claim 1, wherein a portion at the portions detouring around the transfer member is removed to form a step between the circumferences of the display region and the portions detouring around the transfer member.

6. A liquid crystal display device according to claim 1, wherein the sealing member includes a filler to maintain the height thereof.

7. A liquid crystal display device according to claim 1, wherein one of the first and second substrates is a pixel array substrate.
